(19) United States
(12) Patent Application Publication
(10) Pub. No.: US 2026/0268640 A1
(43) Pub. Date: Sep. 10, 2026

(54) METHOD AND SYSTEM FOR TRAINING A CAR PARTS DETECTOR ON RGB DATA WITH TWO LABELS

(71) Applicant: Toyota Research Institute, Inc., Los Altos, CA (US)

(72) Inventors: Kiyomasa Akaike, San Jose, CA (US); Mark Edward Tjersland, Mountain View, CA (US)

(73) Assignees: Toyota Research Institute, Inc., Los Altos, CA (US); Toyota Jidosha Kabushiki Kaisha, Toyota-shi (JP)

(21) Appl. No.: 19/071,077

(22) Filed: Mar. 5, 2025

(51) Int. Cl. G06V 10/774; G06V 20/64; G06V 20/70

(52) U.S. Cl. CPC G06V 10/774; G06V 20/64; G06V 20/70

(57) ABSTRACT

A method may include generating an image of a virtual car part in a virtual container at a selected position and having a selected orientation, placing a first bounding box around the virtual car part and a second bounding box around the virtual container in the image, generating a training example by labeling the first bounding box around the virtual car part with a first label, and labeling the second bounding box around the virtual container with a second label, and training a machine learning model to identify a car part and a container in a second I mage, using training data including the training example.

### TECHNICAL FIELD

The present specification relates to training a car parts detector, and more particularly to a method and system for training a car parts detector on RGB data with two labels.

### BACKGROUND

A robot may be used to pick car parts from a container. In particular, the robot may capture an image of an open container and identify car parts within the container based on the image. The robot may then pick one or more of the identified car parts using a robot arm or other physical device.

However, current technology cannot localize car parts in images accurately. Identifying specific car parts in images typically requires extensive training of a model, and retraining of the model whenever car parts change (e.g., due to production updates). Moreover, obtaining real data for training a car parts detector presents significant challenges due to the presence of confidential information, such as proprietary manufacturing methods and intricate car part designs. Additionally, it may not be practical to modify lighting conditions or introduce unconventional objects in factories to gather high-quality datasets. Such issues may incur substantial costs, which may hinder factory automation. As such, there is a need for an improved car parts detector.

### SUMMARY

In one embodiment, a method may include generating an image of a virtual car part in a virtual container at a selected position and having a selected orientation, placing a first bounding box around the virtual car part and a second bounding box around the virtual container in the image, generating a training example by labeling the first bounding box around the virtual car part with a first label, and labeling the second bounding box around the virtual container with a second label, and training a machine learning model to identify a car part and a container in a second image, using training data including the training example.

In another embodiment, a computing device may include one or more processors configured to generate an image of a virtual car part in a virtual container at a selected position and having a selected orientation, place a first bounding box around the virtual car part and a second bounding box around the virtual container in the image, generate a training example by labeling the first bounding box around the virtual car part with a first label, and label the second bounding box around the virtual container with a second label, and train a machine learning model to identify a car part and a container in a second image, using training data including the training example.

In another embodiment, a non-transitory computer readable storage medium may include a memory storing a program. When executed by a processor, the program may cause the processor to generate an image of a virtual car part in a virtual container at a selected position and having a selected orientation, place a first bounding box around the virtual car part and a second bounding box around the virtual container in the image, generate a training example by labeling the first bounding box around the virtual car part with a first label, and labeling the second bounding box around the virtual container with a second label, and train a machine learning model to identify a car part and a container in a second image, using training data including the training example.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts an example computing device or training a car parts detector on RGB data with two labels, according to one or more embodiments shown and described herein;

FIG. 2 schematically depicts a plurality of memory modules of the computing device of FIG. 1, according to one or more embodiments shown and described herein;

FIG. 3A depicts an example image of virtual car parts in a virtual container, according to one or more embodiments shown and described herein;

FIG. 3B depicts another example image of virtual car parts in a virtual container, according to one or more embodiments shown and described herein;

FIG. 4 depicts another example image of virtual car parts in a virtual container, according to one or more embodiments shown and described herein;

FIG. 5 depicts another example image of virtual car parts in a virtual container, according to one or more embodiments shown and described herein;

FIG. 6A depicts another example image of virtual car parts in a virtual container, according to one or more embodiments shown and described herein;

FIG. 6B depicts a depth map of the image of FIG. 6A, according to one or more embodiments shown and described herein;

FIG. 6C depicts the example image of FIG. 6A with bounding boxes around the virtual car parts and the virtual containers;

FIG. 7 depicts an image that may be output by the computing device of FIG. 1, according to one or more embodiments shown and described herein;

FIG. 8 depicts a flowchart of an example method for operating the computing device of FIG. 1, according to one or more embodiments shown and described herein; and

FIG. 9 depicts another flowchart of an example method for operating the computing device of FIG. 1, according to one or more embodiments shown and described herein.

### DETAILED DESCRIPTION

The embodiments disclosed herein describe methods and systems for training a car parts detector on RGB data with two labels. In particular, virtual car parts may be randomly selected from a database to be used as training data for a machine learning model. The database may include images of real car parts and/or computer generated images of car parts. The selected car parts may be placed in a virtual container at random positions with random orientations. A physics engine may then be used to allow the virtual car parts to settle at natural resting positions and orientations. An image of the virtual car parts at the resting positions and in the virtual container may then be generated. A random background may be applied to the image, and one or more non-car part distractors may be placed in the image. The generated image may then be used as one training example for the machine learning model. Bounding boxes may be placed around the car parts and the container in the image, and the bounding boxes may be labeled to be used as ground truth data. In particular, a first label may be applied to bounding boxes associated with the car parts, and a second label may be applied to the bounding box associated with the container.

A large number of training examples may be generated in such a manner with different virtual car parts, different virtual containers, different positions and orientations of the virtual car parts, different backgrounds, and different distractors. All of the training examples may be used as training data to train a machine learning model to receive an image including one or more car parts in a container and classify the container and the car parts in the image (e.g., by drawing different bounding boxes around the car parts and the container). A robot may then use the trained machine learning model to identify real car parts in an actual container and pick out the identified car parts using a robotic arm or other mechanism. While the embodiments disclosed herein are directed to training a machine learning model to detect car parts in one or more containers, in other examples, the disclosed machine learning model may be used to train a machine learning model to detect other objects in one or more containers.

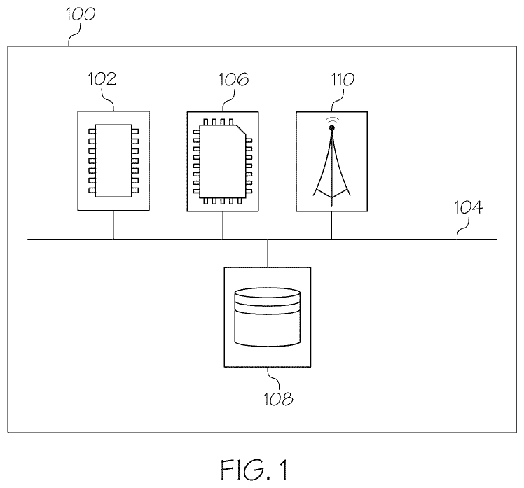

Turning now to the figures, FIG. 1 schematically depicts an example configuration of a computing device 100, according to the embodiments disclosed herein. The computing device 100 may comprise a variety of different types of devices (e.g., a local computing system, a cloud computing system, and the like). The computing device 100 may perform the operations of the embodiments disclosed herein. In the illustrated example, the computing device 100 includes one or more processors 102, a communication path 104, one or more memory modules 106, a data storage component 108, and network interface hardware 110, the details of which will be set forth in the following paragraphs.

Each of the one or more processors 102 may be any device capable of executing machine readable and executable instructions. Accordingly, each of the one or more processors 102 may be a controller, an integrated circuit, a microchip, a computer, or any other physical or cloud-based computing device. The one or more processors 102 are coupled to a communication path 104 that provides signal interconnectivity between various modules of the computing device 100. Accordingly, the communication path 104 may communicatively couple any number of processors 102 with one another, and allow the modules coupled to the communication path 104 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 104 may be formed from any medium that is capable of transmitting a signal such as, for example, conductive wires, conductive traces, optical waveguides, or the like. In some embodiments, the communication path 104 may facilitate the transmission of wireless signals, such as WiFi, Bluetooth®, Near Field Communication (NFC) and the like. Moreover, the communication path 104 may be formed from a combination of mediums capable of transmitting signals. In one embodiment, the communication path 104 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

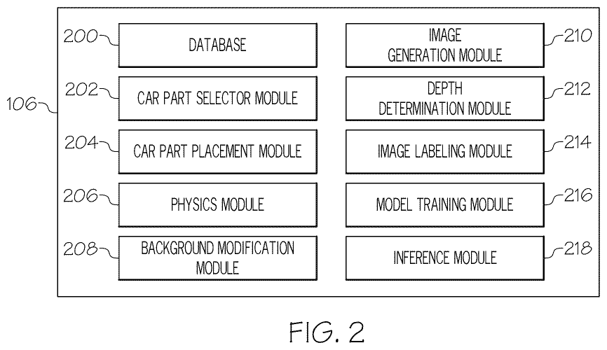

The computing device 100 includes one or more memory modules 106 coupled to the communication path 104. The one or more memory modules 106 may comprise RAM, ROM, flash memories, hard drives, or any device capable of storing machine readable and executable instructions such that the machine readable and executable instructions can be accessed by the one or more processors 102. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 106. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 106 are discussed in more detail below in connection with FIG. 2.

Referring still to FIG. 1, the example computing device 100 includes a data storage component 108. The data storage component 108 may store data used by the computing device 100. The data storage component 108 may also store other data used by the various components of the computing device 100.

Still referring to FIG. 1, the computing device 100 comprises network interface hardware 110 for communicatively coupling the computing device 100 to the external computing devices. As such, the network interface hardware 110 may send data to and/or receive data from various external computing devices. The network interface hardware 110 may comprise a wired and/or wireless connection to one or more external computing devices. In other examples, the network interface hardware 110 may be send data to and/or receive data from other computing devices.

The network interface hardware 110 can be communicatively coupled to the communication path 104 and can be any device capable of transmitting and/or receiving data via a network. Accordingly, the network interface hardware 110 can include a communication transceiver for sending and/or receiving any wired or wireless communication. For example, the network interface hardware 110 may include an antenna, a modem, LAN port, Wi-Fi card, WiMax card, mobile communications hardware, near-field communication hardware, satellite communication hardware and/or any wired or wireless hardware for communicating with external computing devices.

Referring now to FIG. 2, the one or more memory modules 106 of the computing device 100 include a database 200, a car part selector module 202, a car part placement module 204, a physics module 206, a background generation module 208, an image generation module 210, a depth determination module 212, an image labeling module 214, a model training module 216, and an inference module 218. Each of the database 200, the car part selector module 202, the car part placement module 204, the physics module 206, the background generation module 208, the image generation module 210, the depth determination module 212, the image labeling module 214, the model training module 216, and the inference module 218 may be a program module in the form of operating systems, application program modules, and other program modules stored in one or more memory modules 106. Such a program module may include, but is not limited to, routines, subroutines, programs, objects, components, data structures and the like for performing specific tasks or executing specific data types as will be described below.

The database 200 may store information about virtual car parts. In particular, the database 200 may comprise a database of virtual car parts to be used to generate training data for a car parts detector, as disclosed herein. The database 200 may also store parameters associated with a machine learning model maintained by the computing device 100, as disclosed herein.

As discussed above, a car part picking robot may utilize a machine learning model to identify car parts in a container. As such, during operation, the robot may capture an image of a container containing one or more car parts (e.g., using a camera), and input the image into a trained machine learning model. The machine learning model identify the car parts in the image, and output a new image with bounding boxes around the car parts in the image. The robot may then pick the identified car parts out of the container (e.g., using a robotic arm).

As such, a machine learning model may be trained to identify car parts in an image. However, as discussed above, using training data comprising images of real car parts may be expensive. It may be time consuming for humans to set up enough different arrangements of car parts to generate sufficient training data to train the model. Furthermore, it may be difficult and time consuming for humans to manually label each and every car part in each image. As such, in embodiments disclosed herein, synthetic data of virtual car parts is used to generate training data for a car parts selector, rather than images of actual car parts.

Accordingly, the database 200 may store a plurality of potential virtual car parts. That is, the database 200 may store parameters associated with virtual car parts. This may include a variety of properties about each such virtual car parts, such as an image of the virtual car part, a shape and size of the virtual car part, a weight of the virtual car part, material properties of the virtual car part, and the like. In some examples, the database 200 may store computer-aided-drafting (CAD) files associated with virtual car parts. As such, as disclosed in further detail below, training data may be generated by selecting virtual car parts from the database 200, and generating images of the selected virtual car parts in a virtual container (e.g., a bin or a tote). As such, in some examples, the database 200 may store data about virtual containers that the virtual car parts may be placed in. In some examples, the virtual containers may have properties matching containers that actual car parts are stored in (e.g. in a factory). After an image is generated, bounding boxes may be placed around the container and the car parts in the image, and the bounding boxes may be labeled, as disclosed in further detail below. Each such generated image may be used as one training example as part of a training data set. The training data may be used to train a machine learning model for a car parts detector, as disclosed herein.

Referring back to FIG. 2, the car part selector module 202 may select one or more virtual car parts from among the potential virtual car parts stored in the database 200 to generate a training example, as disclosed herein. In order to generate sufficient training data to train the machine learning model, a large number of training examples may be included with different training examples comprising a variety of different numbers and types of car parts in a variety of different configurations (e.g., in different positions and orientations). As such, the car part selector module 202 may select virtual car parts for each such training example.

In some examples, the car part selector module 202 may randomly select the number, size, and/or types of virtual car parts from the database 200. In some examples, the car part selector module 202 may only select a number of virtual car parts up to a predetermined maximum number of virtual car parts (e.g., a maximum of 10 virtual car parts), or a maximum aggregate size of virtual car parts. Setting a maximum number or maximum aggregate size of virtual car parts to select may prevent the car part selector module 202 from selecting too many car parts to fit in a virtual container.

In some examples, a user may specify the maximum number of virtual car parts that the car part selector module 202 may select. In these examples, the car part selector module 202 may first randomly select a number of virtual car parts to select (e.g., between 1 and the specified or predetermined maximum number). The car part selector module 202 may then randomly select a number of virtual car parts equal to the selected random number. In some examples, a user may specify the exact number of car parts to be selected for a particular training example. In other examples, the car part selector module 202 may select different numbers of car parts for each training example. For example, the car part selector module 202 may randomly select 1 virtual car part for a certain number of training examples, 2 virtual car parts for some number of other training examples, 3 virtual car parts for a number of other training examples, and so on, up to the maximum number of car parts to be selected. In some examples, a user may specify a range of sizes for the virtual car parts, and the car part selector module 202 may select only car parts within the specified range of sizes.

While the above examples describe the car part selector module 202 randomly selecting virtual car parts from the potential virtual car parts in the database 200, in other examples, the car part selector module 202 may select virtual car parts in a more deterministic, non-random manner. For example, the potential virtual car parts in the database 200 may be organized into categories, and for a particular training example, the car part selector module 202 may only select car parts within a single category. In other examples, the car part selector module 202 may select car parts from different categories. In some examples, the car part selector module 202 may select different combinations of car parts from the potential virtual car parts in the database 200 using some predetermined method (e.g., using Monte Carlo selection to determine the different combinations).

In some examples, the car part selector module 202 may also select a virtual container to place the selected virtual car parts in. In some examples, the car part selector module 202 may randomly select a virtual container from among potential virtual containers stored in the database 200. In some examples, the car part selector module 202 may select a single container to include in an image, while in other examples, the car part selector module 202 may include multiple containers to include in an image. In some examples, the car part selector module 202 may randomly select a number of containers to include in an image up to a predetermined or selected maximum number. In some examples, a user may specify a virtual container or containers to be used. In some examples, the car part selector module 202 may select different virtual containers (e.g., containers of different colors, shapes, and sizes) for different training examples using a predetermined selection method.

Referring still to FIG. 2, the car part placement module 204 may place the virtual car parts selected by the car part selector module 202 in the virtual container selected by the car part selector module 202, as disclosed herein. As described herein, placing a virtual car part in a virtual container means determining a position and orientation of the virtual car part in the virtual container (e.g., by using a CAD program).

In embodiments, the car part placement module 204 may randomly select initial positions and initial orientations for the virtual car parts in the virtual container selected by the car part selector module 202. However, the car part placement module 204 may select the initial positions and initial orientations for each virtual car part in a training example such that the virtual car parts do not overlap with each other, which would not be physically possible for real car parts. In one example, the car part placement module 204 may randomly select an initial position and an initial orientation for a first virtual car part in a training example. The car part placement module 204 may then randomly select an initial position and an initial orientation for a second virtual car part in the training example such that the second virtual car part does not overlap with the first virtual car part. This process may be continued for each virtual car part in a training example. By randomly selecting different virtual car parts and placing them in a variety of different positions and orientations, training data may be generated containing a wide variety of training examples, which may allow the machine learning module to be better trained.

Referring still to FIG. 2, the physics module 206 may use a physics engine to simulate natural movement of the virtual car parts placed in the virtual container until they settle at resting positions and resting orientations. As discussed above, the car part placement module 204 may place the selected virtual car parts at random positions in the virtual container with random orientations. However, this may result in virtual car parts being placed in positions that would not be possible with real car parts. For example, virtual car parts may be placed at unnatural angles or on top of each other, which would cause real car parts to fall or tip over. As such, training the machine learning model with training examples having such

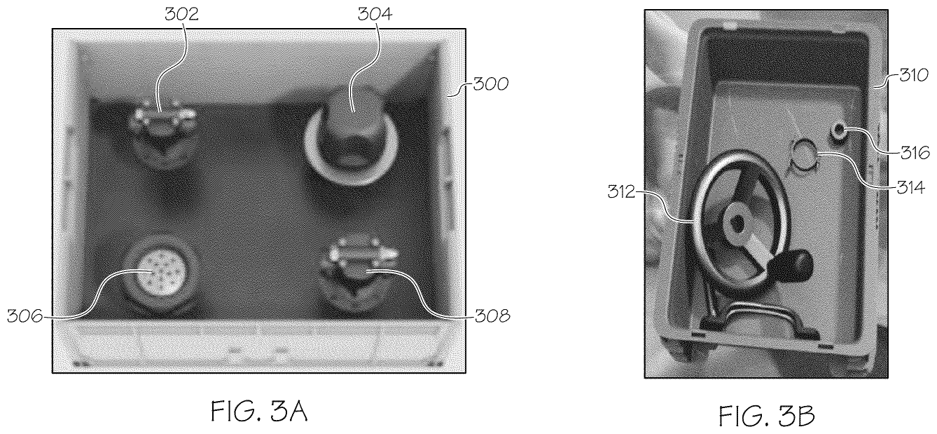

FIG. 3A shows an example image of virtual car parts 302, 304, 306, 308 that may be placed in virtual container 300 by the car part placement module 204. In the example of FIG. 3A, each virtual car part 302, 304, 306, 308 is placed at an unstable angle, such as balancing on a narrow end. If real car parts were arranged in this manner, they would tip over. As such, the image of FIG. 3A does not represent an actual possible arrangement of car parts, and as such would be a poor training example.

Accordingly, the physics module 206 may use a physics engine to simulate movement of the car parts placed by the car part placement module 204 in a virtual container, as disclosed herein. As discussed above, the database 200 stores physical properties of the potential virtual car parts (e.g., size, shape, weight, materials). As such, after the selected virtual car parts are placed in the virtual container, the physics module 206 may use a physics engine to determine how the virtual car parts would naturally move when placed in the initial positions with initial orientations.

For example, the physics engine may apply gravity to the virtual car parts and account for collisions between the virtual car parts and/or with the virtual container to allow the virtual car parts to settle at stable locations and orientations. Once the virtual car parts stop moving after being acted upon by the physics engine, their final positions and orientations, which may be referred to herein as resting positions and resting orientations, may be used for a training example. As such, the training examples used to train the machine learning model may comprise more realistic scenarios of how real car parts may be arranged in real life scenarios. FIG. 3B shows an image of virtual container 310 containing virtual car parts 312, 314, 316. In the example of FIG. 3B, the physics module 206 has been used to allow the virtual car parts 312, 314, 316 to settle at resting positions resting orientations. As such, the image of FIG. 3B shows car parts in an arrangement that could actually exist in real life.

Referring back to FIG. 2, the background generation module 208 may generate or modify a background of an image to be used in a training example. In a real life situation in which a robot is picking car parts from an actual container, there may be a background image around the container holding the car parts. If this is not accounted for in training the machine learning module, the robot may be confused and unable to distinguish between the car parts and items in the background. As such, the background generation module 208 may generate or modify a background of training example images in order to improve the robustness of the training data and the quality of the training of the machine learning model.

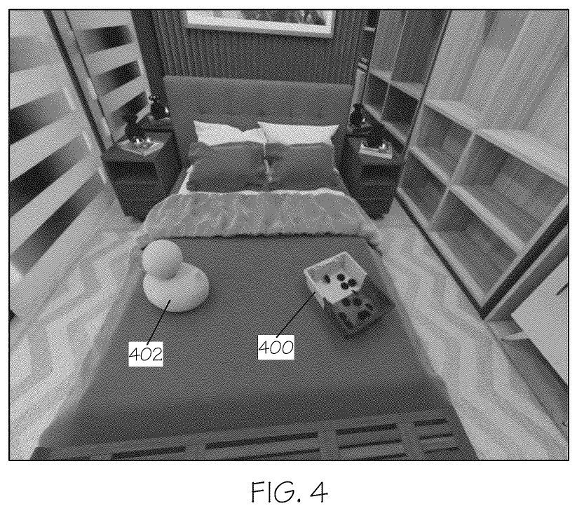

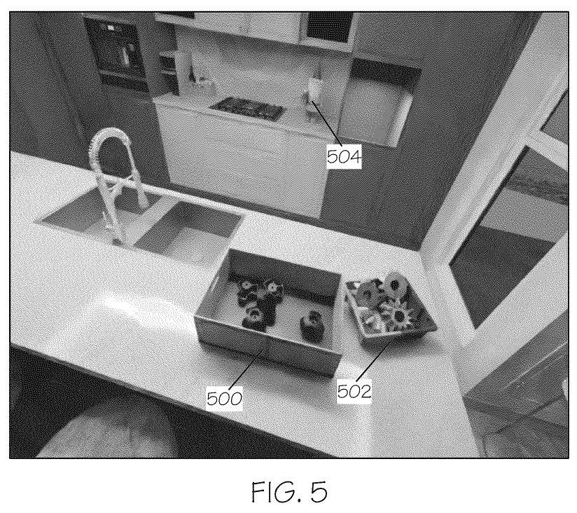

In some examples, the database 200 may contain a number of predetermined background images. As such, in embodiments the background generation module 208 may apply one of these predetermined background images to a training example image. For example, FIG. 4 shows an image with a container 400 full of car parts and a background of a bedroom. FIG. 5 shows an image with containers 500 and 502 full of car parts and a background of a kitchen. Other potential backgrounds may include an office, a factory, a retail store, and the like. Different training examples may have different backgrounds. As such, the training data may be more varied and robust and may improve the performance of the machine learning module after training (e.g., by preventing the machine learning model from overfitting to a limited set of data with particular backgrounds).

Another issue that a car parts detector may run into is other objects in an image outside of a car parts container. Accordingly, in some examples, the background generation module 208 may place images of non-car part items in the background, which may be referred to herein as distractors. In some examples, the database 200 may store images of a variety of distractors and the background generation module 208 may randomly select one or more distractors from this database to be added to an image. In the example of FIG. 4, a rubber duck 402 is added as a distractor. In the example of FIG. 5, a glue bottle 504 is added as a distractor. By adding distractors to training examples, the machine learning model may be trained to ignore such distractors when identifying car parts and car part containers.

Referring back to FIG. 2, the image generation module 210 may generate an RGB image of one or more containers each containing one or more car parts. In particular, the image generation module 210 may generate an image containing the containers and car parts selected by the car part selector module 202. The car parts may be placed in the container or containers at the positions and orientations determined by the car part placement module 204 and the physics module 206, as discussed above. The image generation module 210 may also generate a background for the image and/or include distractors in the image as determined by the background generation module 208. As such, the image generated by the image generation module 210 may include one or more containers each containing one or more car parts along with a background, which may include one or more distractors.

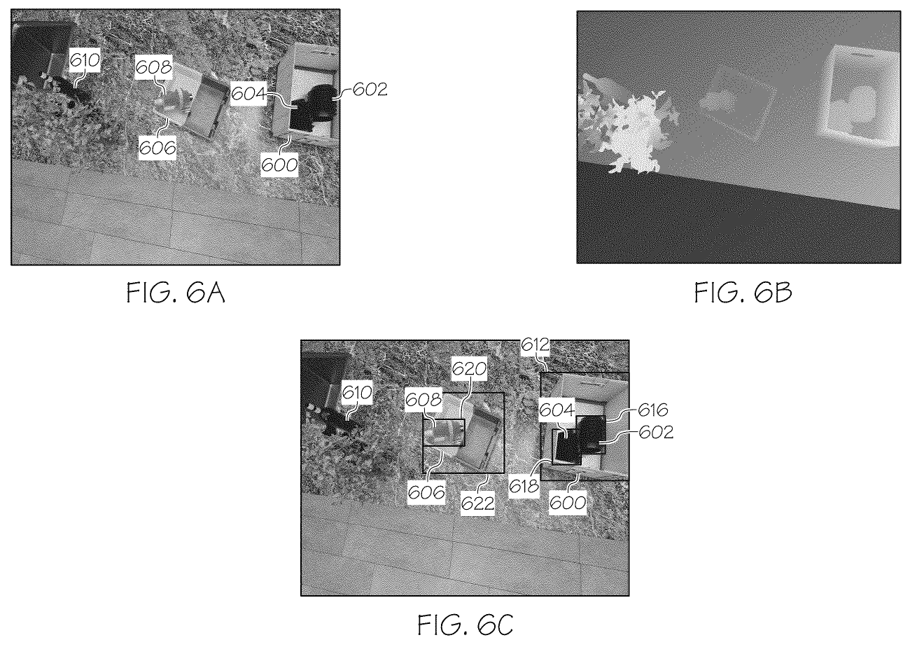

FIG. 6A shows an example image that may be generated by the image generation module 210. The example image of FIG. 6A includes a container 600 which has car parts 602 and 604, and a container 606 which has car part 608. The example image of FIG. 6A also has a background which includes a distractor 610.

Referring back to FIG. 2, the depth determination module 212 may determine depth values for the pixels of the image generated by the image generation module 210, as disclosed herein. As disclosed in further detail below, after a plurality of images are generated by the image generation module 210, using the techniques discussed above, a machine learning model may be trained using the plurality of labeled images as training data to identify car parts and containers in the training data images. In some examples, the training data comprises only RGB images. However, in other examples, training of the machine learning model may be enhanced by also include a depth map comprising depth values for the pixels of each image. As such, in some examples, the depth determination module 212 may determine such a depth map.

In some examples, the image generation module 210 generates a left image and a right image of the scene containing the selected containers, car parts, background, and distractors. That is, the image generation module 210 may generate two images of the scene from different perspectives. In these examples, the depth determination module 212 may determine a depth map for the scene based on the left image and the right image. For example, the left image and the right image may be input to a neural network that outputs a depth map based on the input images. In other examples, the depth determination module 212 may determine a depth map directly, based on the components of the generated image. For example, the image generation module 210 may place the components of the image (e.g., the container, the car parts, the distractors) at particular locations in a background with known depth values. As such, the depth determination module 212 may determine a depth map comprising the known depth values. FIG. 6B shows an example depth map of the image of FIG. 6A. In embodiments where the depth values are used to train the model, the image generated by the image generation module 210 may be concatenated with the depth values determined by the depth determination module 212 to determine the training examples.

Referring back to FIG. 2, the image labeling module 214 may label the image generated by the image generation module 210, as disclosed herein. In particular, the image labeling module 214 may place bounding boxes around the containers and the car parts in the generated images. The image labeling module 214 may then give a first label (e.g., a “car parts” label) to the bounding boxes around the car parts, and a second label (e.g., a “container” label) to the bounding boxes around the containers. These labels may be used as ground truth values during training of the machine learning model, as disclosed in further detail below. FIG. 6C shows an example image that may be generated by the image labeling module 214. In particular, the example of FIG. 6C shows the image of FIG. 6A with a bounding box 612 placed around the container 600, a bounding box 616 placed around the car part 602, a bounding box 618 placed around the car part 604, a bounding box 620 placed around the car part 608, and a bounding box 622 placed around the container 606.

In embodiments disclosed herein, the image labeling module 214 only generates two labels, one for car parts and one for containers. By using only two labels, the machine learning model may be trained more efficiently and cost-effectively than using multiple labels, without a reduction in the accuracy of the machine learning model may be improved. In particular, testing has shown that adding a label for distractors or other objects in the image can actually decrease the accuracy of the machine learning model. Furthermore, testing has shown that using the label for containers in addition to the label for car parts increases the accuracy of the machine learning model as opposed using only one label for car parts. This is true even when the container includes other materials, such as dividers.

Because the image of the container and car parts was generated by the image generation module 210, the computing device 100 may be aware of the exact locations of the container and the car parts in the image. As such, the image labeling module 214 may place the bounding boxes around the container and the car parts based on these known locations. Each image generated by the image generation module 210 and labeled by the image labeling module 214 may be used as a training example. Once a sufficient number of such training examples are generated, the machine learning model may be trained using data comprising all of the generated training examples, as disclosed in further detail below.

Referring still to FIG. 2, the model training module 216 may train the machine learning model maintained by the computing device 100, as disclosed herein. In particular, the model training module 216 may train the machine learning model to receive an input RGB image and a depth map associated with the image, and output a modified image with bounding boxes placed around any containers and car parts within the containers in the image. The bounding boxes may be labeled as either relating to a container or a car part. In some examples, the machine learning model may be trained to receive only an RGB image without an associated depth map.

In embodiments, the machine learning model maintained by the computing device 100 may be a classifier that can identify and classify containers and car parts in the image. In some examples, the machine learning model maintained by the computing device 100 may be a neural network, which may have any type of neural network architecture. In other examples, the machine learning model may be another type of model.

In embodiments, the model training module 216 may train the machine learning model using supervised learning techniques. In particular, the model training module 216 may receive training data comprising a plurality of training examples. As discussed above, each such training example may comprise an image generated by the image generation module 210 and bounding boxes with labels generated by the image labeling module 214. In some examples, each training example may also comprise a depth map generated by the depth determination module 212 associated with the image. Accordingly, the model training module 216 may train the machine learning model using supervised learning techniques, and using the labeled bounding boxes as ground truth values. As the machine learning model is trained, parameters associated with the machine learning model may be continually updated until training is complete. Once training is complete, the final learned parameters of the machine learning model may be stored in the database 200.

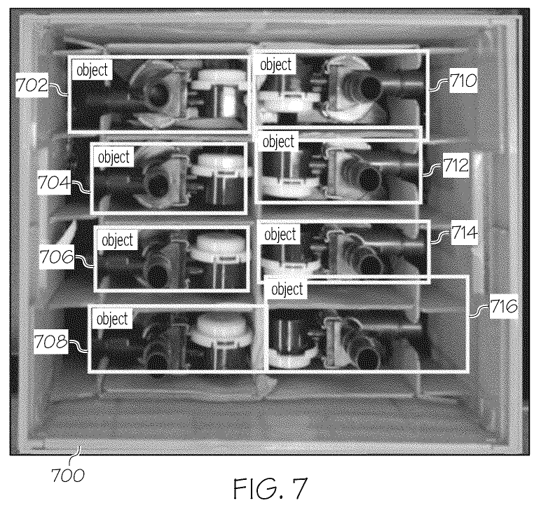

Referring still to FIG. 2, the inference module 218 may perform inference using the trained machine learning model. In particular, the inference module 218 may receive an image containing one or more car parts. The inference module 218 may input the image into the trained machine learning model, and the model may output a modified image showing bounding boxes around the car parts in the image. FIG. 7 shows an example image that may be output by the inference module 218. As shown in the example of FIG. 7, the image includes a bounding box 700 around a container, and bounding boxes 702, 704, 706, 708, 710, 712, 714, and 716 around car parts in the container.

In some examples, a robot may use the computing device 100 to pick car parts from a container. For example, the robot may capture an image of the container (e.g., using a camera), and the inference module 218 may input the image into the trained machine learning model. The trained machine learning model may then output a modified image showing bounding boxes around any identified car parts in the image. The robot may then pick one or more of the identified car parts out of the container. In particular, a robot arm or other mechanism may grab items at locations in the container specified by the bounding boxes in the image output by the machine learning model, and remove the items it grabs. As such, the robot may use the machine learning model maintained by the computing device 100 to identify and pick items from a container.

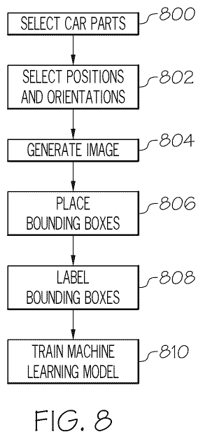

FIG. 8 depicts a flowchart of an example method that may be performed by the computing device 100 to train the machine learning model. At step 800, the car part selector module 202 selects a virtual car part. As discussed above, the car part selector module 202 may randomly select a virtual car part from a database of virtual car parts. In some examples, the car part selector module 202 may select multiple virtual car parts.

At step 802, the car part placement module 204 selects a position and an orientation for the virtual car part selected by the car part selector module 202 to be placed in a virtual container. In some examples, the car part placement module 204 may select an initial position and an initial orientation of the selected virtual car part and the physics module 206 may determine a final resting position and resting orientation of the virtual car part using a physics simulation. If multiple virtual car parts a selected, the car part placement module 204 may select positions and orientations for each of the selected virtual car parts.

At step 804, the image generation module 210 generates an RGB image of the virtual car part selected by the car part selector module 202 in a virtual container at the second position and having the selected orientations. In some examples, the background generation module 208 may generate a background and/or one or more distractors that the image generation module 210 may place in the image.

At step 806, the image labeling module 214 places a first bounding box around the virtual car part and places a second bounding box around the virtual container. At step 808, the image labeling module 214 labels the bounding boxes. In particular, the image labeling module 214 labels the first bounding box around the virtual car part with a first label (e.g., a “car part” or “object” label), and labels the second bounding box around the container with a second label (e.g., a “container” label). If multiple virtual car parts and/or virtual containers are selected, bounding boxes may be placed around each of the virtual car parts and/or virtual containers, and may label each of the bounding boxes appropriately.

At step 810, the model training module 216 trains the machine learning model, as discussed above, using images generated by the image generation module 210 as training examples, and using the labeled bounding boxes generated by the image labeling module 214 as ground truth data. In particular, the model training module 216 may train the machine learning model to identify a car part and a container in a second image, using training data including the training example.

In some examples, the depth determination module 212 may generate depth maps for the images generated by the image generation module 210, and these depth maps may also be included in the training examples. As discussed above, the model training module 216 may train the machine learning model to receive, as input, an image of one or more containers each containing one or more car parts, and output a modified image showing first bounding boxes around the containers and second bounding boxes around the car parts. This may allow a robot to pick out car parts from the containers based on the locations of the bounding boxes in the modified image.

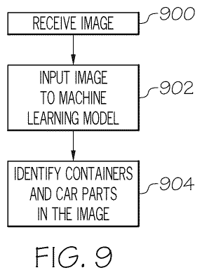

FIG. 9 depicts a flowchart of an example method that may be performed by the computing device 100 after the machine learning model has been trained. At step 900, the inference module 218 receives an image of one or more containers containing one or more car parts. At step 902, the inference module 218 inputs the received image into the trained machine learning module. At step 904, the machine learning module outputs a modified image with bounding boxes placed around the one or more containers and the one or more car parts, and the inference module 218 may identify the containers and the car parts in the image based on this modified image. In some examples, a robot may then pick one or more of the car parts out of the one or more containers based on the identified locations of the containers and car parts.

It should now be understood that embodiments described herein are directed to a method and system for training a car parts detector on RGB data with two labels. By using synthetic data to train a car parts detector, the synthetic data can be automatically labeled, thereby allowing a large amount of training data to be generated without the need for humans to collect and label the training data. Furthermore, by using only two labels to label the training data, containers and car parts, the training efficiency and accuracy of the machine learning model associated with the car parts detector can be improved.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method comprising:
generating an image of a virtual car part in a virtual container at a selected position and having a selected orientation;
placing a first bounding box around the virtual car part and a second bounding box around the virtual container in the image;
generating a training example by labeling the first bounding box around the virtual car part with a first label, and labeling the second bounding box around the virtual container with a second label; and
training a machine learning model to identify a car part and a container in a second image, using training data including the training example.

2. The method of claim 1, further comprising training the machine learning model using supervised learning, wherein the first label and the second label comprise ground truth values.

3. The method of claim 1, further comprising:
receiving an input number of virtual car parts to be included in the image; and
generating a number of virtual car parts in the image equal to the input number.

4. The method of claim 1, further comprising:
receiving an input range of sizes of virtual car parts to be included in the image; and
generating virtual car parts in the image having sizes within the input range of sizes.

5. The method of claim 1, further comprising selecting the virtual car part from among a database of potential virtual car parts.

6. The method of claim 5, further comprising randomly selecting the virtual car part from among the database of potential virtual car parts.

7. The method of claim 1, further comprising randomly selecting the position and the orientation of the virtual car part.

8. The method of claim 1, further comprising inserting one or more non-car part objects into the image.

9. The method of claim 1, further comprising generating a background for the image by randomly selecting a background from among a plurality of potential background images.

10. The method of claim 1, further comprising determining a resting position and a resting orientation for the virtual car part in the virtual container based on the selected position, the selected orientation, and a physics simulation.

11. The method of claim 1, further comprising:
determining depth values of pixels in the image; and
modifying the training example to include the determined depth values.

12. The method of claim 1, further comprising:
receiving the second image that includes one or more car parts in the container;
inputting the second image into the trained model; and
identifying the one or more car parts and the container in the second image based on an output of the trained model.

13. A computing device comprising one or more processors configured to:
generate an image of a virtual car part in a virtual container at a selected position and having a selected orientation;
place a first bounding box around the virtual car part and a second bounding box around the virtual container in the image;
generate a training example by labeling the first bounding box around the virtual car part with a first label, and label the second bounding box around the virtual container with a second label; and
train a machine learning model to identify a car part and a container in a second image, using training data including the training example.

14. The computing device of claim 13, wherein the one or more processors are further configured to train the machine learning model using supervised learning, wherein the first label and the second label comprise ground truth values.

15. The computing device of claim 13, wherein the one or more processors are further configured to insert one or more non-car part objects into the image.

16. The computing device of claim 13, wherein the one or more processors are further configured to generate a background for the image by randomly selecting a background from among a plurality of potential background images.

17. The computing device of claim 13, wherein the one or more processors are further configured to determine a resting position and a resting orientation for the virtual car part in the virtual container based on the selected position, the selected orientation, and a physics simulation.

18. The computing device of claim 13, wherein the one or more processors are further configured to:
determine depth values of pixels in the image; and
modify the training example to include the determined depth values.

19. The computing device of claim 13, wherein the one or more processors are further configured to:
receive a second image that includes one or more car parts in a container;
input the second image into the trained model; and
identify the one or more car parts and the container in the second image based on an output of the trained model.

20. A non-transitory computer readable storage medium comprising a memory storing a program that, when executed by a processor, causes the processor to:
generate an image of a virtual car part in a virtual container at a selected position and having a selected orientation;
place a first bounding box around the virtual car part and a second bounding box around the virtual container in the image;
generate a training example by labeling the first bounding box around the virtual car part with a first label, and labeling the second bounding box around the virtual container with a second label; and
train a machine learning model to identify a car part and a container in a second image, using training data including the training example.
